(19) United States
(12) Patent Application Publication
(10) Pub. No.: US 2024/0166533 A1
(43) Pub. Date: May 23, 2024

(54) HIGH-NICKEL TERNARY CORE-SHELL PRECURSOR, POSITIVE ELECTRODE MATERIAL AND PREPARATION METHOD THEREFOR

(71) Applicant: JINGMEN GEM CO., LTD., Jingmen, Hubei (CN)

(72) Inventors: Kaihua XU, Jingmen (CN); Kun ZHANG, Jingmen (CN); Dongming JIA, Jingmen (CN); Cong LI, Jingmen (CN); Xing YANG, Jingmen (CN); Xiaofei XUE, Jingmen (CN); Liangjiao FAN, Jingmen (CN); Xiaofei CHEN, Jingmen (CN); Xueqian LI, Jingmen (CN); Xiaoshuai ZHU, Jingmen (CN); Hao LV, Jingmen (CN); Wenfang YUAN, Jingmen (CN); Ding WANG, Jingmen (CN); Xianjin YUE, Jingmen (CN)

(73) Assignee: JINGMEN GEM CO., LTD., Jingmen, Hubei (CN)

(21) Appl. No.: 18/284,475

(22) PCT Filed: Aug. 18, 2022
(86) PCT No.: PCT/CN2022/113432

§ 371 Date: Sep. 27, 2023

(30) Foreign Application Priority Data
Dec. 2, 2021 (CN) 202111458529.4

(51) Int. Cl. C01G 53/00; H01M 4/02; H01M 4/04; H01M 4/525; H01M 10/052

(52) U.S. Cl. CPC C01G 53/50; H01M 4/0471; H01M 4/525; H01M 10/052; C01P 2004/03; C01P 2006/40; H01M 2004/028

(57) ABSTRACT

A high-nickel ternary core-shell precursor for a lithium battery, a positive electrode material and a preparation method therefor. The chemical structural formula of the precursor is zNi(C₄H₇N₂O₂)₂—Ni_{x-z}M1_{y}M2_{1-x-y}(OH)₂, wherein M1 and M2 are two of cobalt, aluminum, and manganese. The preparation method comprises: pumping a prepared metal salt solution, a dimethylglyoxime-ammonia water composite solution, and an ammonia water solution into a reaction kettle, maintaining the pH of a reaction system, and controlling the reaction time to obtain a sphere-like precursor inner core with a structural formula of Ni(C₄H₇N₂O₂)₂; pumping the metal salt solution and the ammonia water solution, stopping pumping the dimethylglyoxime-ammonia water composite solution, pumping a sodium hydroxide solution to obtain a sphere-like core-shell precursor, washing, drying, sieving and deironing the precursor, mixing with a lithium source, and calcining to prepare the positive electrode material. The material can keep high capacity and also has excellent cycle performance.

### TECHNICAL FIELD

The present disclosure relates to the technical field of lithium battery materials, in particular to a high-nickel ternary core-shell precursor for a lithium battery, a positive electrode material and a preparation method therefor.

### BACKGROUND

In recent years, with the arrival of energy crisis and the need to reduce carbon emissions, new energy vehicles have emerged in people's vision and occupied an increasing share in the market. However, if the new energy vehicles need to further develop and completely replace traditional fuel vehicles, the problem of “mileage anxiety” needs to be solved, which requires core components, namely power lithium batteries, of the new energy vehicles to have higher energy density. In order to meet this requirement, it is needed to select a high-energy-density positive electrode material which can work stably.

Among several current mainstream positive electrode materials, a lithium-rich manganese-based positive electrode has a low cost and high capacity, but its irreversible capacity is relatively large during the first cycle, and the voltage and capacity attenuation during the cycle is large. As the multiplying power increases, its capacity also rapidly decreases, which makes it difficult to realize commercial applications. At present, in the field of power batteries, the positive electrodes which are mainly applied are two commercial materials such as lithium iron phosphate and a ternary layered oxide material. Lithium iron phosphate has the advantages of low cost, good cycle performance and good safety, but its capacity is low. With the improvement of a process, the specific capacity has become closer to its theoretical limit, and there is little space for improvement in the future. Moreover, its poor low-temperature performance also limits its application range. The ternary layered oxide material has good capacity density, good cycle performance and high compaction density, moreover, with the increase of Ni content, its actual specific capacity also increases, and in terms of solving the problem of “mileage anxiety”, the ternary layered oxide material has more advantages. Therefore, in future development, the ternary layered oxide material will gradually occupy the mainstream position in the field of power batteries.

Although a high-nickel ternary layered oxide material has high specific capacity, the high Ni content also reduces its stability, which leads to poor cycle performance and safety of high-nickel materials, greatly affecting its application in the field of the power batteries. Therefore, how to improve the stability of the high-nickel ternary layered oxide material has become a research hotspot for some scientists, and it is currently believed that a core-shell structure is an effective means to improve the stability. However, the conventional co-precipitation method for preparing core-shell precursors requires changing the proportion of ternary solutions, which is not conducive to operation. However, configuring different proportions of ternary solutions also requires increasing the number of storage tanks, which increases device costs.

### SUMMARY OF THE INVENTION

Aiming at above shortcomings existing in the prior art, the present disclosure provides a high-nickel ternary core-shell precursor for a lithium battery, a positive electrode material and a preparation method therefor.

The present disclosure is implemented through the following technical solution.

A high-nickel ternary core-shell precursor, characterized in that a chemical structural formula of the precursor is zNi(C₄H₇N₂O₂)₂—Ni_{x-z}M1_{y}M2_{1-x-y}(OH)₂, where, 0.6≤x≤0.9, 0.05≤y≤0.2, 0<z≤0.24, and M1 and M2 are two of cobalt, aluminum and manganese.

A method for preparing the above precursor, characterized by including:
(1) preparing a metal salt solution of 2-4 mol/L by using soluble nickel salt, soluble metal M1 salt and soluble metal M2 salt with a molar ratio of Ni:M1:M2=x:y:(1-x-y), where 0.6≤x≤0.9, and 0.05≤y≤0.2, and preparing a dimethylglyoxime-ammonia water composite solution, a sodium hydroxide solution and an ammonia-water solution respectively;
(2) adding a base solution and introducing N₂ into a reaction kettle, raising a temperature to a range from 40° C. to 60° C., pumping the metal salt solution, the dimethylglyoxime-ammonia water composite solution, and the ammonia-water solution which are prepared in step (1) into the reaction kettle, maintaining pH of a reaction system at a range from 8.0 to 10.0, and reacting for 4 h to 20 h to obtain a sphere-like precursor core with a structural formula of Ni(C₄H₇N₂O₂)₂; and
(3) keeping pumping the metal salt solution and the ammonia-water solution, stopping pumping the dimethylglyoxime-ammonia water composite solution, pumping the sodium hydroxide solution prepared in step (1) into the reaction kettle, maintaining pH of the reaction system at a range from 9.0 to 12.0, continuing to react for 30 h to 80 h to obtain a sphere-like core-shell precursor with a structural formula of zNi(C₄H₇N₂O₂)₂—Ni_{x-z}M1_{y}M2_{1-x-y}(OH)₂, where 0.6≤x≤0.9, 0.05≤y≤0.2, and 0<z≤0.24.

Further, the soluble nickel salt in step (1) is one or more of nickel sulfate, nickel chloride, and nickel nitrate; and the soluble metal M1 salt and the soluble metal M2 salt are two of soluble cobalt salt, soluble aluminum salt, and soluble manganese salt.

Further, the soluble cobalt salt is one of cobalt sulfate, cobalt chloride, and cobalt nitrate; the soluble aluminum salt is one of aluminum sulfate, sodium metaaluminate, and aluminum nitrate; and the soluble manganese salt is one of manganese sulfate, manganese chloride, and manganese nitrate.

Further, the dimethylglyoxime-ammonia water composite solution is prepared by dissolving dimethylglyoxime (C₄H₈N₂O₂) in concentrated ammonia liquor, where a ratio of the dimethylglyoxime to the concentrated ammonia liquor is 1 g:(10-200 ml), and a concentration of the concentrated ammonia liquor is 25% to 28%; and concentrations of the sodium hydroxide solution and the ammonia-water solution are both 2 mol/L.

Further, the base solution in step (2) is prepared by adding water with 2/3 of a volume of the reaction kettle into the reaction kettle, then adding ammonia water with the concentration of 10% to 28% and adjusting pH to a range from 8.0 to 10.0, with a flow rate of N₂ being from 0.5 m³/h to 2 m³/h.

Further, in a reaction process of step (2), the metal salt solution has a flow rate of ranging from 1 L/h to 50 L/h, the dimethylglyoxime-ammonia water composite solution has a flow rate of ranging from 3 L/h to 10 L/h, and the ammonia-water solution has a flow rate of ranging from 0 L/h to 3 L/h; and a stirring speed is in a range from 200 r/min to 400 r/min.

Further, in a reaction process of step (3), the sodium hydroxide solution has a flow rate of ranging from 1 L/h to 17 L/h, and a stirring speed is in a range from 300 r/min to 400 r/min.

A positive electrode material prepared using the above precursor, characterized in that a structural formula of the positive electrode material is LiNiₓM1_{y}M2_{1-x-y}O₂, where 0.65≤x≤0.9, and 0.05≤y≤0.2.

A method for preparing the above positive electrode material, characterized by including: washing, drying, sieving and deironing the core-shell precursor, then mixing with a lithium source, maintaining a temperature at a range from 300° C. to 500° C. for 3 h to 5 h, then raising a temperature to a range from 700° C. to 900° C. and maintaining for 10 h to 20 h, where the lithium source is lithium hydroxide or lithium carbonate; and a molar ratio of the lithium source to the core-shell precursor is (1-1.2):1.

The beneficial technical effects of the present disclosure are that a ternary precursor of a core-shell structure is prepared by a co-precipitation method, the characteristic reaction of the dimethylglyoxime with Ni ions is utilized to form the precursor of the core-shell structure with a core nickel content of 100% and a low shell nickel content without changing a chemical ratio of a ternary solution. The positive electrode material of the core-shell structure is obtained after mixing with lithium and calcining, compared with ordinary materials with the same chemical ratio, the core-shell material can maintain high capacity, and also has excellent cycle performance. At the same time, the operation process is also simplified, and the number of storage tanks is reduced.

### BRIEF DESCRIPTION OF THE DRAWINGS

FIG. 1 is an SEM image of a ternary precursor in Embodiment 3.

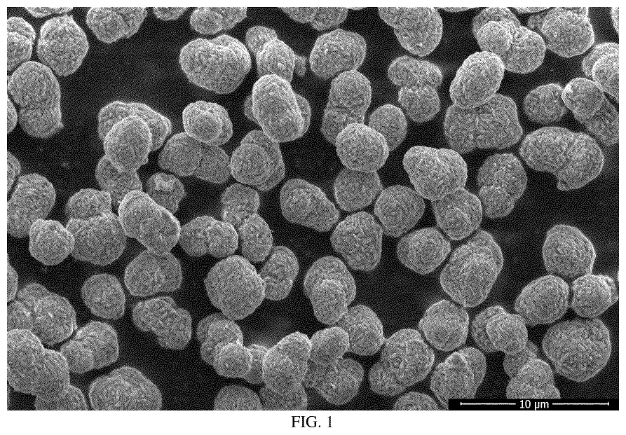

### DETAILED DESCRIPTION

The present disclosure is described in detail below with reference to accompanying drawings and specific implementations.

Dimethylglyoxime of the present disclosure may undergo a characteristic reaction with Ni ions, and a core-shell structure with a core nickel content of 100% and a low shell nickel content may be obtained by utilizing the reaction. Therefore, when the chemical ratio is the same, compared with ordinary materials, the core-shell material can maintain high capacity, and also has excellent cycle performance.

### Embodiment 1

Step 1. A metal salt solution of 2 mol/L is prepared by using nickel nitrate, cobalt nitrate, and manganese nitrate with a molar ratio of Ni:Co:Mn=0.6:0.2:0.2, dimethylglyoxime (C₄H₈N₂O₂) is dissolved in concentrated ammonia liquor of 25% to 28% to prepare a dimethylglyoxime-ammonia water composite solution of 10 g/L, and sodium hydroxide and ammonia water are prepared into solutions with concentrations being both 2 mol/L respectively;
step 2. water of 130 L (namely 2/3 of a volume of a reaction kettle) is added into the reaction kettle, the ammonia water of 14% to 16% is used to adjust pH to a range from 8.0 to 9.0, N₂ is introduced into the reaction kettle with a flow rate being 0.6 m³/h, a temperature is raised to 50° C., the above metal salt solution of 8 L/h, the dimethylglyoxime-ammonia water composite solution of 10 L/h and the ammonia-water solution of ranging from 0 L/h to 3 L/h are pumped into the reaction kettle, pH in the reaction kettle is maintained at a range from 8.0 to 9.0, a stirring speed is in a range from 340 r/min to 380 r/min, and reaction is performed for 10 h to obtain a sphere-like precursor core with a structural formula of Ni(C₄H₇N₂O₂)₂;
step 3. pumping of the metal salt solution and the ammonia-water solution is kept, pumping the dimethylglyoxime-ammonia water composite solution is stopped, the 2 mol/L sodium hydroxide solution of ranging from 1.4 L/h to 1.6 L/h is pumped into the reaction kettle, pH in the reaction is maintained at a range from 9.4 to 10.0, the stirring speed is in a range from 340 r/min to 380 r/min, and reaction is continued for 60 h to obtain a sphere-like core-shell precursor with a structural formula of 0.1Ni(C₄H₇N₂O₂)₂—Ni_{0.5}Co_{0.2}Mn_{0.2}(OH)₂; and
step 4. the above core-shell precursor is washed, dried, sieved and deioned, and then is mixed with lithium carbonate, a temperature is maintained at 400° C. for 5 h, and then the temperature is raised to 800° C. and maintained for 12 h to obtain a ternary material of a core-shell structure with a structural formula of LiNi_{0.6}Co_{0.2}Mn_{0.2}O₂, where a molar ratio of the lithium carbonate to the precursor is 1.2:1. The positive electrode material is assembled into a CR2025 button battery and subjected to electrochemical performance testing, and results show that at a multiplying power of 0.1 C and within a voltage range of 2.8V to 4.3V, a discharge capacity is 182.1 mA/g, and a capacity retention rate for 100 cycles at 0.5 C is 92.9%.

### Embodiment 2

Step 1. A metal salt solution of 2 mol/L is prepared by using nickel chloride, cobalt chloride and manganese chloride with a molar ratio of Ni:Co:Mn=0.8:0.1:0.1, dimethylglyoxime (C₄H₈N₂O₂) is dissolved in concentrated ammonia liquor of 25% to 28% to prepare a dimethylglyoxime-ammonia water composite solution of 10 g/L, and sodium hydroxide and ammonia water are prepared into solutions with concentrations being both 2 mol/L respectively;
step 2. water of 130 L is added into a reaction kettle, the ammonia water of 14% to 16% is used to adjust pH to a range from 8.0 to 9.0, N₂ is introduced into the reaction kettle with a flow rate being 0.6 m³/h, a temperature is raised to 50° C., the above metal salt solution of 8 L/h, the dimethylglyoxime-ammonia water composite solution of 10 L/h and the ammonia-water solution of ranging from 0 L/h to 3 L/h are pumped into the reaction kettle, pH in the reaction is maintained at a range from 8.0 to 9.0, a stirring speed is in a range from 340 r/min to 380 r/min, and reaction is performed for 10 h to obtain a sphere-like precursor core with a structural formula of Ni(C₄H₇N₂O₂)₂;
step 3. pumping of the metal salt solution and the ammonia-water solution is kept, pumping the dimethylglyoxime-ammonia water composite solution is stopped, the 2 mol/L sodium hydroxide solution of ranging from 1.4 L/h to 1.6 L/h is pumped into the reaction kettle, pH in the reaction is maintained at a range from 9.6 to 11.0, the stirring speed is in a range from 340 r/min to 380 r/min, and reaction is continued for 55 h to obtain a sphere-like core-shell precursor with a structural formula of 0.1Ni(C₄H₇N₂O₂)₂—Ni_{0.7}Co_{0.1}Mn_{0.1}(OH)₂; and
step 4. the above core-shell precursor is washed, dried, sieved and deioned, and then is mixed with lithium hydroxide, a temperature is maintained at 400° C. for 5 h, then the temperature is raised to 800° C. and maintained for 12 h to obtain a ternary material of a core-shell structure with a structural formula of LiNi_{0.8}Co_{0.1}Mn_{0.1}O₂, a molar ratio of the lithium hydroxide to the precursor is 1.2:1. The positive electrode material is assembled into a CR2025 button battery and subjected to electrochemical performance testing, and results show that at a multiplying power of 0.1 C and within a voltage range of 2.8V to 4.3V, a discharge capacity is 191.4 mA/g, and a capacity retention rate for 100 cycles at 0.5 C is 92.3%.

### Embodiment 3

Step 1. A metal salt solution of 2 mol/L is prepared by using nickel sulfate, cobalt sulfate, and manganese sulfate with a molar ratio of Ni:Co:Mn=0.9:0.05:0.05, dimethylglyoxime (C₄H₈N₂O₂) is dissolved in concentrated ammonia liquor of 25% to 28% to prepare a dimethylglyoxime-ammonia water composite solution of 10 g/L, and sodium hydroxide and ammonia water are prepared into solutions with concentrations being both 2 mol/L respectively;
step 2. water of 130 L is added into a reaction kettle, the ammonia water of 14% to 16% is used to adjust pH to a range from 8.0 to 9.0, N₂ is introduced into the reaction kettle with a flow rate being 0.6 m³/h, a temperature is raised to 50° C., the above metal salt solution of 8 L/h, the dimethylglyoxime-ammonia water composite solution of 10 L/h and the ammonia water solution of ranging from 0 L/h to 3 L/h are pumped into the reaction kettle, pH in the reaction is maintained at a range from 8.0 to 9.0, a stirring speed is 340 r/min to 380 r/min, and reaction is performed for 10 h to obtain a sphere-like precursor core with a structural formula of Ni(C₄H₇N₂O₂)₂;
step 3. pumping of the metal salt solution and the ammonia-water solution is kept, pumping the dimethylglyoxime-ammonia water composite solution is stopped, the 2 mol/L sodium hydroxide solution of ranging from 1.4 L/h to 1.6 L/h is pumped into the reaction kettle, pH in the reaction is maintained at a range from 11.0 to 12.0, the stirring speed is in a range from 340 r/min to 380 r/min, and reaction is continued for 50 h to obtain a sphere-like core-shell precursor with a structural formula of 0.1Ni(C₄H₇N₂O₂)₂—Ni_{0.8}Co_{0.05}Mn_{0.05}(OH)₂; and
step 4. the above core-shell precursor is washed, dried, sieved and deioned, and then is mixed with lithium hydroxide, a temperature is maintained at 400° C. for 5 h, then the temperature is raised to 800° C. and maintained for 12 h to obtain a ternary material of a core-shell structure with a structural formula of LiNi_{0.9}Co_{0.05}Mn_{0.05}O₂, where a molar ratio of the lithium hydroxide to the precursor is 1.2:1. The positive electrode material is assembled into a CR2025 button battery and subjected to electrochemical performance testing, and results show that at a multiplying power of 0.1 C and within a voltage range of 2.8V to 4.3V, a discharge capacity is 217.1 mA/g, and a capacity retention rate for 100 cycles at 0.5 C is 90.3%.

### Embodiment 4

Step 1. A metal salt solution of 3 mol/L is prepared by using nickel sulfate, cobalt sulfate, and sodium metaaluminate with a molar ratio of Ni:Co:Al=0.8:0.15:0.05, dimethylglyoxime (C₄H₈N₂O₂) is dissolved in concentrated ammonia liquor of 25% to 28% to prepare a dimethylglyoxime-ammonia water composite solution of 10 g/L, and sodium hydroxide and ammonia water are prepared into solutions with concentrations being both 2 mol/L respectively;
step 2. water of 130 L is added into a reaction kettle, the ammonia water of 14% to 16% is used to adjust pH to a range from 8.0 to 9.0, N₂ is introduced into the reaction kettle with a flow rate being 0.6 m³/h, a temperature is raised to 58° C., the above metal salt solution of 30 L/h, the dimethylglyoxime-ammonia water composite solution of 5 L/h and the ammonia water solution of ranging from 0 L/h to 3 L/h are pumped into the reaction kettle, pH in the reaction is maintained at a range from 9.0 to 10.0, a stirring speed is in a range from 340 r/min to 360 r/min, and reaction is performed for 20 h to obtain a sphere-like precursor core with a structural formula of Ni(C₄H₇N₂O₂)₂;
step 3. pumping of the metal salt solution and the ammonia-water solution is kept, pumping the dimethylglyoxime-ammonia water composite solution is stopped, the 2 mol/L sodium hydroxide solution of ranging from 8 L/h to 10 L/h is pumped into the reaction kettle, pH in the reaction is maintained at a range from 9.2 to 9.8, the stirring speed is in a range from 380 r/min to 400 r/min, and reaction is continued for 70 h to obtain a sphere-like core-shell precursor with a structural formula of 0.2Ni(C₄H₇N₂O₂)₂—Ni_{0.6}Co_{0.15}Al_{0.05}(OH)₂; and
step 4. the above core-shell precursor is washed, dried, sieved and deioned, and then is mixed with lithium carbonate, a temperature is maintained at 500° C. for 3 h, and then the temperature is raised to 900° C. and maintained for 11 h to obtain a ternary material of a core-shell structure with a structural formula of LiNi_{0.8}Co_{0.15}Al_{0.05}O₂, where a molar ratio of the lithium carbonate to the precursor is 1.1:1. The positive electrode material is assembled into a CR2025 button battery and subjected to electrochemical performance testing, and results show that at a multiplying power of 0.1 C and within a voltage range of 2.8V to 4.3V, a discharge capacity is 190.3 mA/g, and a capacity retention rate for 100 cycles at 0.5 C is 90.2%.

### Embodiment 5

Step 1. A metal salt solution of 4 mol/L is prepared by using nickel sulfate, cobalt sulfate, and aluminum nitrate with a molar ratio of Ni:Co:Al=0.89:0.1:0.01, dimethylglyoxime (C₄H₈N₂O₂) is dissolved in concentrated ammonia liquor of 25% to 28% to prepare a dimethylglyoxime-ammonia water composite solution of 10 g/L, and sodium hydroxide and ammonia water are prepared into solutions with concentrations being both 2 mol/L respectively;
step 2. water of 130 L is added into a reaction kettle, the ammonia water of 14% to 16% is used to adjust pH to a range from 8.0 to 9.0, N₂ is introduced into the reaction kettle with a flow rate being 1.5 m³/h, a temperature is raised to 58° C., the above metal salt solution of 45 L/h, the dimethylglyoxime-ammonia water composite solution of 5 L/h and the ammonia-water solution of 0 L/h to 2 L/h are pumped into the reaction kettle, pH in the reaction is maintained at a range from 8.0 to 9.0, a stirring speed is in a range from 340 r/min to 360 r/min, and reaction is performed for 20 h to obtain a sphere-like precursor core with a structural formula of Ni(C₄H₇N₂O₂)₂;
step 3. pumping of the metal salt solution and the ammonia-water solution is kept, pumping the dimethylglyoxime-ammonia water composite solution is stopped, the 2 mol/L sodium hydroxide solution of ranging from 15 L/h to 17 L/h is pumped into the reaction kettle, pH in the reaction is maintained at a range from 10.0 to 11.4, the stirring speed is in a range from 300 r/min to 320 r/min, and reaction is continued for 65 h to obtain a sphere-like core-shell precursor with a structural formula of 0.24Ni(C₄H₇N₂O₂)₂—Ni_{0.65}Co_{0.1}Al_{0.01}(OH)₂; and
step 4. the above core-shell precursor is washed, dried, sieved and deioned, and then is mixed with lithium hydroxide, a temperature is maintained at 300° C. for 4 h, and then the temperature is raised to 850° C. and maintained for 10 h to obtain a ternary material of a core-shell structure with a structural formula of LiNi_{0.89}Co_{0.1}Al_{0.01}O₂, where a molar ratio of the lithium hydroxide to the precursor is 1.2:1. The positive electrode material is assembled into a CR2025 button battery and subjected to electrochemical performance testing, and results show that at a multiplying power of 0.1 C and within a voltage range of 2.8V to 4.3V, a discharge capacity is 210.4 mA/g, and a capacity retention rate for 100 cycles at 0.5 C is 91.4%.

### Embodiment 6

Step 1. A metal salt solution of 2 mol/L is prepared by using nickel sulfate, manganese sulfate and aluminum sulfate with a molar ratio of Ni:Mn:Al=0.9:0.05:0.05, dimethylglyoxime (C₄H₈N₂O₂) is dissolved in concentrated ammonia liquor of 25% to 28% to prepare a dimethylglyoxime-ammonia water composite solution of 10 g/L, and sodium hydroxide and ammonia water are prepared into solutions with concentrations being both 2 mol/L respectively;
step 2. water of 130 L is added into a reaction kettle, the ammonia water of 14% to 16% is used to adjust pH to a range from 8.0 to 9.0, N₂ is introduced into the reaction kettle with a flow rate being 0.6 m³/h, a temperature is raised to 58° C., the above metal salt solution of 40 L/h, the dimethylglyoxime-ammonia water composite solution of 8 L/h and the ammonia-water solution of ranging from 2 L/h to 3 L/h are pumped into the reaction kettle, pH in the reaction is maintained at a range from 8.0 to 9.0, a stirring speed is in a range from 340 r/min to 360 r/min, and reaction is performed for 10 h to obtain a sphere-like precursor core with a structural formula of Ni(C₄H₇N₂O₂)₂;
step 3. pumping of the metal salt solution and the ammonia-water solution is kept, pumping the dimethylglyoxime-ammonia water composite solution is stopped, the 2 mol/L sodium hydroxide solution of ranging from 13 L/h to 15 L/h is pumped into the reaction kettle, pH in the reaction is maintained at a range from 11.0 to 12.0, the stirring speed is in a range from 360 r/min to 380 r/min, and reaction is continued for 50 h to obtain a sphere-like core-shell precursor with a structural formula of 0.1Ni(C₄H₇N₂O₂)₂—Ni_{0.8}Mn_{0.05}Al_{0.05}(OH)₂; and
step 4. the above core-shell precursor is washed, dried, sieved and deioned, and then is mixed with lithium hydroxide, a temperature is maintained at 400° C. for 5 h, and then the temperature is raised to 800° C. and maintained for 12 h to obtain a ternary material of a core-shell structure with a structural formula of LiNi_{0.9}Mn_{0.05}Al_{0.05}O₂, where a molar ratio of the lithium hydroxide to the precursor is 1.2:1. The positive electrode material is assembled into a CR2025 button battery and subjected to electrochemical performance testing, and results show that at a multiplying power of 0.1 C and within a voltage range of 2.8V to 4.3V, a discharge capacity is 209.7 mA/g, and a capacity retention rate for 100 cycles at 0.5 C is 90.1%.

The above are only preferred embodiments of the present disclosure without limiting the present disclosure. It should be noted that for those ordinarily skilled in the art, under the technical inspiration provided by the present disclosure, other equivalent improvements can further be made, which can realize objectives of the present disclosure and should fall within the protection scope of the present disclosure.

1. A high-nickel ternary core-shell precursor, wherein a chemical structural formula of the precursor is zNi(C₄H₇N₂O₂)₂—Ni_{x-z}M1_{y}M2_{1-x-y}(OH)₂, wherein, 0.6≤x≤0.9, 0.05≤y≤0.2, 0<z≤0.24, and M1 and M2 are two of cobalt, aluminum and manganese.

2. A method for preparing the precursor of claim 1, comprising:
(1) preparing a metal salt solution of 2-4 mol/L by using soluble nickel salt, soluble metal M1 salt and soluble metal M2 salt with a molar ratio of Ni:M1:M2=x:y:(1-x-y), wherein 0.6≤x≤0.9 and 0.05≤y≤0.2, and preparing a dimethylglyoxime-ammonia water composite solution, a sodium hydroxide solution and an ammonia-water solution respectively;
(2) adding a base solution and introducing N₂ into a reaction kettle, raising a temperature to a range from 40° C. to 60° C., pumping the metal salt solution, the dimethylglyoxime-ammonia water composite solution, and the ammonia-water solution which are prepared in step (1) into the reaction kettle, maintaining pH of a reaction system at a range from 8.0 to 10.0, and reacting for 4 h to 20 h to obtain a sphere-like precursor core with a structural formula of Ni(C₄H₇N₂O₂)₂; and
(3) keeping pumping the metal salt solution and the ammonia-water solution, stopping pumping the dimethylglyoxime-ammonia water composite solution, pumping the sodium hydroxide solution prepared in step (1) into the reaction kettle, maintaining pH of the reaction system at a range from 9.0 to 12.0, continuing to react for 30 h to 80 h to obtain a sphere-like core-shell precursor with the structural formula of zNi(C₄H₇N₂O₂)₂—Ni_{x-z}M1_{y}M2_{1-x-y}(OH)₂, wherein 0.6≤x≤0.9, 0.05≤y≤0.2, and 0<z≤0.24.

3. The method of claim 2, wherein the soluble nickel salt in step (1) is one or more of nickel sulfate, nickel chloride, and nickel nitrate; and the soluble metal M1 salt and the soluble metal M2 salt are two of soluble cobalt salt, soluble aluminum salt, and soluble manganese salt.

4. The method of claim 3, wherein the soluble cobalt salt is one of cobalt sulfate, cobalt chloride, and cobalt nitrate; the soluble aluminum salt is one of aluminum sulfate, sodium metaaluminate, and aluminum nitrate; and the soluble manganese salt is one of manganese sulfate, manganese chloride, and manganese nitrate.

5. The method of claim 2, wherein the dimethylglyoxime-ammonia water composite solution is prepared by dissolving dimethylglyoxime (C₄H₈N₂O₂) in concentrated ammonia liquor, wherein a ratio of the dimethylglyoxime to the concentrated ammonia liquor is 1 g:(10-200 ml), and a concentration of the concentrated ammonia liquor is 25% to 28%; and concentrations of the sodium hydroxide solution and the ammonia-water solution are both 2 mol/L.

6. The method of claim 2, wherein the base solution in step (2) is prepared by adding water with 2/3 of a volume of the reaction kettle into the reaction kettle, then adding ammonia water with the concentration of 10% to 28% and adjusting pH to a range from 8.0 to 10.0, with a flow rate of N₂ being from 0.5 m³/h to 2 m³/h.

7. The method of claim 2, wherein in a reaction process of step (2), the metal salt solution has a flow rate of ranging from 1 L/h to 50 L/h, the dimethylglyoxime-ammonia water composite solution has a flow rate of ranging from 3 L/h to 10 L/h, and the ammonia-water solution has a flow rate of ranging from 0 L/h to 3 L/h; and a stirring speed is in a range from 200 r/min to 400 r/min.

8. The method of claim 2, wherein in a reaction process of step (3), the sodium hydroxide solution has a flow rate of ranging from 1 L/h to 17 L/h, and a stirring speed is in a range from 300 r/min to 400 r/min.

9. A positive electrode material prepared using the precursor of claim 1, wherein a structural formula of the positive electrode material is LiNiₓM1_{y}M2_{1-x-y}O₂, wherein 0.6≤x≤0.9 and 0.05≤y≤0.2.

10. A method for preparing the positive electrode material of claim 9, wherein the method comprises: washing, drying, sieving and deironing the core-shell precursor, then mixing with a lithium source, maintaining a temperature at a range from 300° C. to 500° C. for 3 h to 5 h, then raising a temperature to a range from 700° C. to 900° C. and maintaining for 10 h to 20 h, wherein the lithium source is lithium hydroxide or lithium carbonate; and a molar ratio of the lithium source to the core-shell precursor is (1-1.2):1.
